(19) United States
(12) Patent Application Publication
(10) Pub. No.: US 2021/0303750 A1
(43) Pub. Date: Sep. 30, 2021

(54) SYSTEM AND METHOD FOR DESIGNING MOLD STRUCTURE OF HIGH STRENGTH STEEL

(71) Applicant: Sewon Precision Industry Co., Ltd., Daegu (KR)

(72) Inventors: MOON KI KIM, Daegu (KR); SANG HYUN KIM, Daegu (KR)

(21) Appl. No.: 16/833,513

(22) Filed: Mar. 28, 2020

(51) Int. Cl. G06F 30/17; B21D 37/20

(52) U.S. Cl. CPC G06F 30/17; B21D 22/02; B21D 37/20

(57) ABSTRACT

A system for designing and manufacturing a mold structure for high-strength steel comprises a 3D modeling unit to design a mold structure based on surface topography information and physical property information about a forming material using a 3D modeling program, a forming load simulation unit to apply stepwise forming loads to a shell of the mold structure while the forming material is formed in the mold structure designed by the 3D modeling unit and to simulate a distribution of the forming loads of the mold structure, a numerical analysis unit to produce a stress and degree of deformation of the mold structure according to the forming load distribution and then analyze a possible wear portion and deformation rate of the wear portion, and an optimal parameter producing unit to provide an reinforcement parameter for reinforcing a design (structural) parameter or physical property value of the wear portion.

### TECHNICAL FIELD

Embodiments of the disclosure relate to a system and method for designing and manufacturing high-strength steel mold structures, and more specifically, a system and method for designing and manufacturing high strength steel mold structures without damage or wear.

### DISCUSSION OF RELATED ART

Worldwide auto industry tends to focus more on better fuel economy due to demand for lightweight car bodies and reinforced regulations on carbon emissions and actively responds by producing high strength steel.

In an effort to develop lightweight car bodies, domestic car manufacturers have adopted, more and more, high strength steel with a tensile strength of 1.0 GPa or more, and have recently started to use those of 1.5 GPa or more.

However, such high strength steel may be difficult to process or handle, and so is it to manufacture molds for producing formed products by using them.

### SUMMARY

According to an embodiment, there is provided a system and method for designing and manufacturing a mold structure for high-strength steel, which may grasp the forming loads applied to the mold by structure analysis and reinforce the portion of the mold where the forming loads are concentrated to thereby allow the forming loads to be evenly distributed, thereby suppressing damage or wear to the formed body (high-strength steel plate).

According to an embodiment, there is provided a system and method for designing and manufacturing a mold structure for high-strength steel, which may reinforce the portion where forming loads are concentrated, thereby reducing the likelihood of defects due to mold deformation.

According to an embodiment, a system for designing and manufacturing a mold structure for high-strength steel comprises a three-dimension (3D) modeling unit configured to design a mold structure based on surface topography information and physical property information about a forming material using a 3D modeling program, a forming load simulation unit configured to apply stepwise forming loads to a shell of the mold structure while the forming material is formed in the mold structure designed by the 3D modeling unit and to simulate a distribution of the forming loads of the mold structure, a numerical analysis unit configured to produce a stress and degree of deformation of the mold structure according to the forming load distribution and then analyze a possible wear portion and deformation rate of the wear portion, and an optimal parameter producing unit configured to provide an reinforcement parameter for reinforcing a design (structural) parameter or physical property value of the wear portion.

The numerical analysis unit is configured to analyze the possible wear portion based on a maximum reference stress depending on a yield strength and forming load of an upper rib and lower rib of the mold structure. A different reference yield strength and reference maximum stress are applied to each of the upper rib and the lower rib.

The optimal parameter producing unit is configured to derive a correlation between parameters of length X, width Y, and height Z and the deformation rate of the wear portion and then produce the reinforcement parameter for distributing the forming loads or suppressing the deformation rate.

Upon determining that it is impossible to suppress the deformation rate due to a variation in design (structural) parameter of the wear portion, a physical property value of the mold structure at which the maximum yield strength may be increased is provided to the 3D modeling unit.

The system further comprises a system controller connected with the 3D modeling unit, the forming load simulation unit, the numerical analysis unit, and the optimal parameter producing unit and configured to control the 3D modeling unit, the forming load simulation unit, the numerical analysis unit, and the optimal parameter producing unit in an organic mechanism.

The system further comprises an error lamp controlled by a system controller to visually output an error in a process of designing and manufacturing a mold structure for high-strength steel, and an error buzzer controlled to be operated along with the error lamp by the system controller to audibly output the error.

According to an embodiment, a method for designing and manufacturing a mold structure for high-strength steel comprises step A of inputting surface topography information and physical property information about a forming material to a 3D modeling unit, by an input unit, step B of designing a primary mold structure fitting a forming shape of the forming material by the 3D modeling unit, step C of simulating a forming load distribution of the primary mold structure by applying stepwise forming loads to a shell of the mold structure while the forming material is formed in the primary mold structure and then detecting a wear portion in the primary mold structure, by a forming load simulation unit, step D of analyzing a stress and degree of deformation of the wear portion based on a yield strength of an upper rib and lower rib of the mold structure and a maximum reference stress according to the forming loads, step E of determining whether the analyzed stress and degree of deformation of the wear portion exceed a reference value, step F of, if exceeding the reference value, deriving a correlation between parameters of length (X), width (Y), and height (Z) and a deformation rate of the wear portion, by the optimal parameter producing unit and, upon determining that it is impossible to suppress the deformation rate due to a variation in design parameter of the wear portion, providing the 3D modeling unit with a mold physical property value at which the maximum yield strength of the upper rib and lower rib is increased, step G of designing a second mold structure to which the design parameter or physical property value varied is applied, by the 3D modeling unit, step H of repeating steps C and D, and step I of, if a wear portion in an Nth order mold structure resultant from performing step H falls within a preset stress and degree of deformation, providing a design parameter of the Nth order mold structure.

The numerical analysis unit applies a different reference yield strength and a different reference maximum stress to each of the upper rib and the lower rib.

According to embodiments, use of the system and method for designing and manufacturing a mold structure for high-strength steel, according to an embodiment enables detecting mold load and an intensive coagulation portion via mold simulation and then reinforcing the intensive coagulation portion, thereby manufacturing a mold structure with a reinforced mold strength.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating a system for designing and manufacturing a mold structure for high-strength steel according to an embodiment;

FIG. 2 is a flowchart illustrating a method for manufacturing a mold structure of high-strength steel according to an embodiment;

FIG. 3 is a view illustrating an example computing environment according to an embodiment; and

FIG. 4 is a block diagram illustrating a system for designing and manufacturing a mold structure for high-strength steel according to an embodiment.

### DETAILED DESCRIPTION OF EXEMPLARY EMBODIMENTS

Hereinafter, embodiments of the present disclosure are described with reference to the accompanying drawings. However, it should be appreciated that the present disclosure is not limited to the embodiments, and all changes and/or equivalents or replacements thereto also belong to the scope of the present disclosure. The same or similar reference denotations may be used to refer to the same or similar elements throughout the specification and the drawings. As used herein, the terms “have,” “may have,” “include,” or “may include” a feature (e.g., a number, function, operation, or a component such as a part) indicate the existence of the feature and do not exclude the existence of other features.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and/or order and are used to distinguish a component from another without limiting the components. For example, a first user device and a second user device may indicate different user devices from each other regardless of the order or importance of the devices. For example, a first component may be denoted a second component, and vice versa without departing from the scope of the present disclosure.

It will be understood that when an element (e.g., a first element) is referred to as being (operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

As used herein, the terms “configured (or set) to” may be interchangeably used with the terms “suitable for,” “having the capacity to,” “designed to,” “adapted to,” “made to,” or “capable of” depending on circumstances. The term “configured (or set) to” does not essentially mean “specifically designed in hardware to.” Rather, the term “configured to” may mean that a device can perform an operation together with another device or parts. For example, the term “processor configured (or set) to perform A, B, and C” may mean a generic-purpose processor (e.g., a CPU or application processor) that may perform the operations by executing one or more software programs stored in a memory device or a dedicated processor (e.g., an embedded processor) for performing the operations.

The terms as used herein are provided merely to describe some embodiments thereof, but not to limit the scope of other embodiments of the present disclosure. It is to be understood that the singular forms “a,” “an,” and “the” include plural references unless the context clearly dictates otherwise. The terms including technical and scientific terms used herein have the same meaning as commonly understood by one of ordinary skill in the art to which the embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the present disclosure.

A system and method for forming or manufacturing high-strength steel plates according to an embodiment are described below in detail.

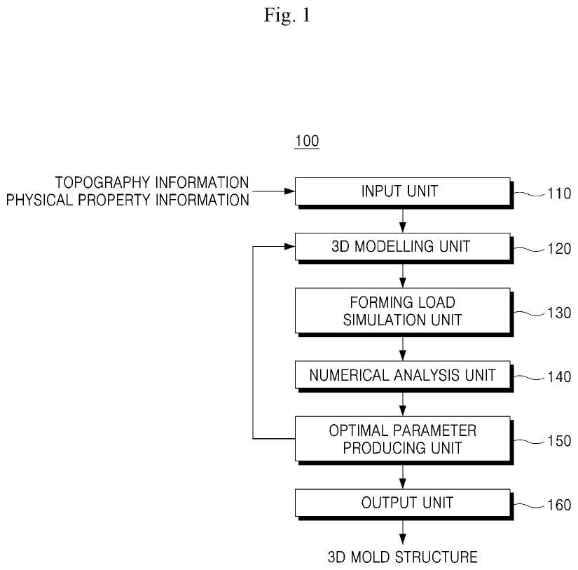

FIG. 1 is a block diagram illustrating a system for designing and manufacturing a mold structure for high-strength steel according to an embodiment. Referring to FIG. 1, a system 100 for manufacturing a mold structure for high-strength steel (hereinafter, simply referred to as system 100) may include an input unit 110, a three-dimension (3D) modeling unit 120, a forming load simulation unit 130, a numerical analysis unit 140, an optimal parameter producing unit 150, and an output unit 160.

The input unit 110 receives shape information and physical property (or material property) information about a forming material from an external source.

The 3D modeling unit 120 designs a mold structure based on the shape information about the forming material using a 3D modeling program or application.

The 3D modeling unit 120 may receive the degree of surface topography of the forming material from the input unit 110.

The forming load simulation unit 130 applies stepwise forming loads to a shell of the mold structure while the forming material is formed in the mold structure designed by the 3D modeling unit 120, thereby simulating a distribution of forming loads of the mold structure.

The numerical analysis unit 140 computes the stress and degree of deformation of the mold structure depending on the distribution of forming loads and then analyzes a possible wear portion and a rate of deformation of the wear portion.

The numerical analysis unit 140 may analyze a possible wear portion based on the yield strength of the upper rib and lower rib of the mold structure and the maximum reference stress according to the forming loads.

Thus, a different reference yield strength and reference maximum stress may be applied to each of the upper rib and the lower rib. The optimal parameter producing unit 150 may provide a reinforcement parameter value for reinforcing the structural parameter or physical value of the wear portion analyzed by the numerical analysis unit 140.

The optimal parameter producing unit 150 derives the correlation between the deformation rate of the wear portion (e.g., a localized area) and the parameters of length X, width Y, and height Z and then produces a reinforcement parameter for suppressing the deformation rate or distributing the forming loads.

The optimal parameter producing unit 150, upon determining that it is impossible to suppress the deformation rate due to variations in the structural parameters, may provide physical values of the mold at which the maximum yield strength may be increased.

The optimal parameter producing unit 150 may provide the produced structural parameter or physical value to the 3D modeling unit 120, and the 3D modeling unit 120 designs a secondary mold structure with the wear portion reinforced.

Then, the forming load simulation unit 130 simulates the distribution of forming loads of the secondary mold structure, and the numerical analysis unit 140 computes the stress and degree of deformation of the secondary mold structure depending on the distribution of forming loads and analyzes a possible wear portion and the deformation rate of the wear portion.

The above-described process is repeated until the stress and degree of deformation of the wear portion in the Nth order mold structure meet a preset stress and degree of deformation.

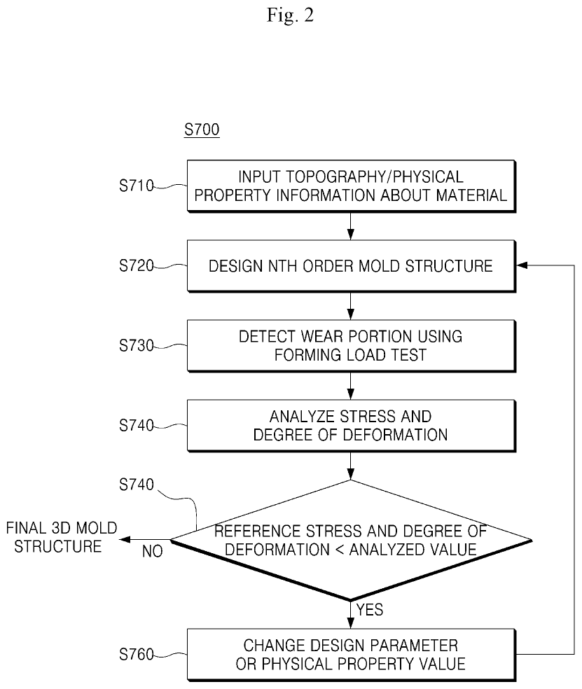

Next, the output unit 160 outputs and displays design information about the final mold structure. FIG. 2 is a flowchart illustrating a method for manufacturing a mold structure of high-strength steel according to an embodiment.

Referring to FIG. 2, a method S700 for designing and manufacturing a mold structure for high-strength steel, according to an embodiment, may be performed using a system for designing and manufacturing a mold structure for high-strength steel as shown in FIG. 1.

First, shape information and physical property (or material property) information about a forming material are input (S710).

The forming material may be a giga-grade high-strength steel plate or sheet. For example, a mold structure according to an embodiment may be a mold structure capable of forming and manufacturing a 1.4 mm-thick high-strength steel plate (or sheet) of 1.5 GPa-grade martensite MART1470.

If the material is selected, a primary mold structure (with an upper rib and a lower rib) is shaped and designed to fit the forming shape of the material using a 3D modeling program or application (S720).

Then, a forming load simulation is applied to the designed primary mold structure (the upper rib and the lower rib) to thereby detect a friction portion and wear portion between the primary mold structure and the material (S730).

In step S730, the friction portion and wear portion are detected using data of forming load generated when the mold pressurizes the material by the program with, e.g., the mechanical properties of the material, the forming speed of the mold, and Coulomb frictional coefficient set therein.

After step S730, the stress and degree of deformation of the detected friction portion and/or wear portion are analyzed (S740).

The upper rib and lower rib of the primary mold structure may have different maximum stresses depending on the yield strength and forming load. Thus, a different reference yield strength and reference maximum stress may be applied to each of the upper rib and the lower rib.

If the stress and degree of deformation analyzed in step S740 are less than a reference deformation rate, the structural parameters or physical properties of the friction portion and wear portion are varied (S750).

The structural parameters may include the length X, width Y, and height Z.

Then, a secondary mold structure to which the varied structural parameters or physical properties have been applied is designed (S760), and then, the above-described steps S730 and S740 are repeated (S770).

If the wear portion in the Nth order mold structure resultant from repeating the above-described process falls within a preset stress and degree of deformation, the design parameters (or structural parameters) of the Nth order mold structure are provided (S780).

Thus, use of the system and method for designing and manufacturing a mold structure for high-strength steel, according to an embodiment enables detecting mold load and an intensive coagulation portion via mold simulation and then reinforcing the intensive coagulation portion, thereby manufacturing a mold structure with a reinforced mold strength.

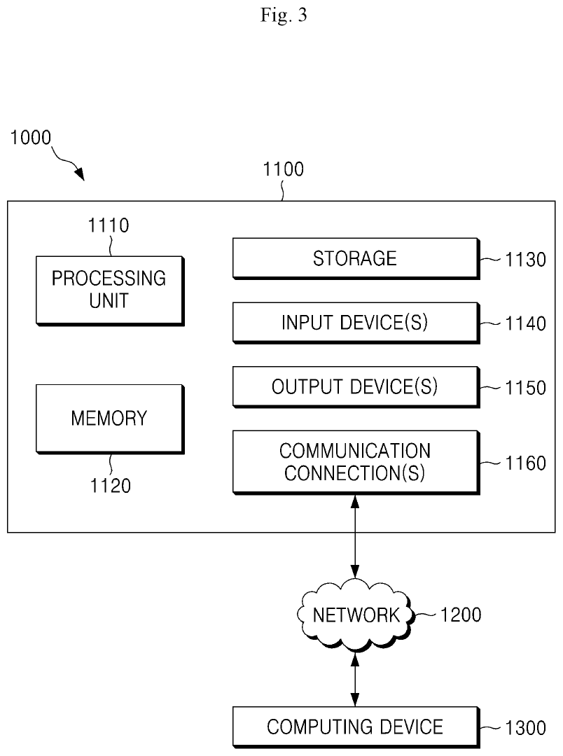

FIG. 3 is a view illustrating an example computing environment in which one or more embodiments of the disclosure may be implemented. FIG. 3 illustrates an example system 1000 including a computing device 1100 configured to implement one or more embodiments as described above. For example, the computing device 1100 may include, but is not limited to, at least one of personal computers, servers, handheld or laptop devices, mobile devices (e.g., mobile phones, personal digital assistances (PDAs), or media players), multi-processor systems, consumer electronic devices, mini computers, main frame computers, or a distributed computing environment including any of the above-described systems or devices.

The computing device 1100 may include at least one processing unit 1110 and at least one memory 1120. The processing unit 1110 may include, e.g., a central processing unit (CPU), a graphic processing unit (GPU), a microprocessor, an application specific integrated circuit (ASIC), or field programmable gate arrays (FPGA). The processing unit may have a plurality of cores. The memory 1120 may be a volatile memory (e.g., a random access memory (RAM), a non-volatile memory (e.g., a read-only memory (ROM) or flash memory), or a combination thereof. The computing device 1100 may include additional storage 1130. The storage 1130 includes, but is not limited to, magnetic storage or optical storage. The storage 1130 may store computer-readable commands (or instructions) to implement one or more embodiments as described above and may further store other computer-readable commands (or instructions) to implement an operating system (OS) or application programs. The computer-readable commands (or instructions) stored in the storage 1130 may be loaded onto the memory 1120 to be executed by the processing unit 1110. The computing device 1100 may include at least one input device 1140 and at least one output device 1150.

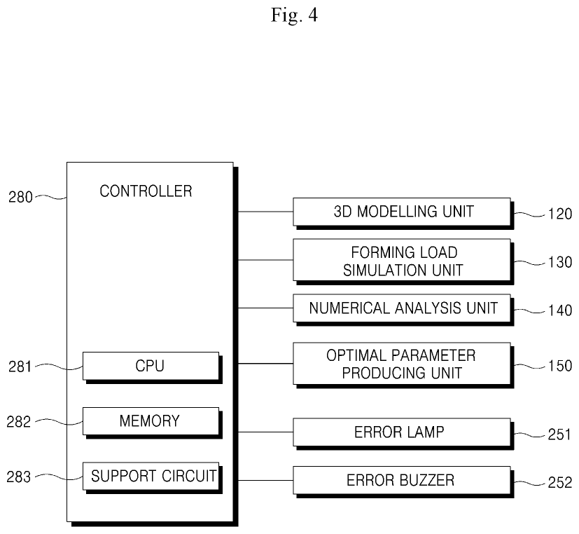

FIG. 4 is a block diagram illustrating a system for designing and manufacturing a mold structure for high-strength steel according to an embodiment. Referring to FIG. 4, according to an embodiment, the system for designing and manufacturing a high-strength steel may further include a system controller 280.

The system controller 280 is connected with the 3D modeling unit 120, the forming load simulation unit 130, the numerical analysis unit 140, and the optimal parameter producing unit 150 and may control them via an organic mechanism.

According to an embodiment, the system for designing and manufacturing a high-strength steel may further include an error lamp 251 and an error buzzer 252. The error lamp 251 and the error buzzer 252 may be connected wiredly or wirelessly.

The error lamp 251 is a device controlled by the system controller 280 to visually output an error in the process of designing and manufacturing a mold structure for high-strength steel.

There may be one or more error lamps 251. The error lamp 251 allows the worker to visually identify and handle errors in the process of designing and manufacturing a mold structure for high-strength steel.

The error buzzer 252 is a device controlled by the system controller 280 to be operated along with the error lamp 251 and to audibly output errors.

There may be one or more error buzzers 252. The error buzzer 252 allows the worker to audibly identify and handle errors in the process of designing and manufacturing a mold structure for high-strength steel.

The system controller 280 may include a central processing unit (CPU) 281, a memory 282, and a support circuit 283.

The central processing unit 281 may be one of various computer processors industrially applicable to be connected with the 3D modeling unit 120, forming load simulation unit 130, numerical analysis unit 140, and optimal parameter producing unit 150 to control them in an organic mechanism or to control the error lamp 251 and error buzzer 252 in an organic mechanism.

The memory 282 is connected with the central processing unit 281. The memory 282 may be a computer-readable recording medium, installable locally or remotely, and may be at least one of, e.g., random access memories (RAMs), read-only memories (ROMs), floppy disks, hard disks, or any other various forms of digital storage.

The support circuit 283 may be coupled with the central processing unit 281 to support typical operations of the processor. The support circuit 283 may include a cache, a power supply, a clock circuit, an input/output circuit, and a sub system.

According to an embodiment, the system controller 280 may be connected with the 3D modeling unit 120, forming load simulation unit 130, numerical analysis unit 140, and optimal parameter producing unit 150 and control them in an organic mechanism, and such a series of control processes may be stored in the memory 282. For example, software routines may be stored in the memory 282. The software routines may be stored or executed by other central processing unit (not shown).

Although the processes are described to be executed by software routines, at least some of the processes according to an embodiment may be performed by hardware. As such, the processes according to an embodiment may be implemented in software executed on a computer system, in hardware, e.g., an integrated circuit (IC), or in a combination of software and hardware.

Such a structure may also provide the effects described herein.

Various changes in form or detail may be made to the present disclosure by one of ordinary skill in the art without departing from the scope of the present disclosure, and the present disclosure is not limited to the above-described embodiments and the accompanying drawings.

What is claimed is:

1. A system for designing and manufacturing a mold structure for high-strength steel, the system comprising:
a three-dimension (3D) modeling unit configured to design a mold structure based on surface topography information and physical property information about a forming material using a 3D modeling program;
a forming load simulation unit configured to apply stepwise forming loads to a shell of the mold structure while the forming material is formed in the mold structure designed by the 3D modeling unit and to simulate a distribution of the forming loads of the mold structure;
a numerical analysis unit configured to produce a stress and degree of deformation of the mold structure according to the forming load distribution and then analyze a possible wear portion and deformation rate of the wear portion; and
an optimal parameter producing unit configured to provide an reinforcement parameter for reinforcing a design (structural) parameter or physical property value of the wear portion.

2. The system of claim 1, wherein the numerical analysis unit is configured to analyze the possible wear portion based on a maximum reference stress depending on a yield strength and forming load of an upper rib and lower rib of the mold structure, and wherein a different reference yield strength and reference maximum stress are applied to each of the upper rib and the lower rib.

3. The system of claim 2, wherein the optimal parameter producing unit is configured to derive a correlation between parameters of length X, width Y, and height Z and the deformation rate of the wear portion and then produce the reinforcement parameter for distributing the forming loads or suppressing the deformation rate.

4. The system of claim 3, wherein upon determining that it is impossible to suppress the deformation rate due to a variation in design (structural) parameter of the wear portion, a physical property value of the mold structure at which the maximum yield strength may be increased is provided to the 3D modeling unit.

5. The system of claim 1, further comprising a system controller connected with the 3D modeling unit, the forming load simulation unit, the numerical analysis unit, and the optimal parameter producing unit and configured to control the 3D modeling unit, the forming load simulation unit, the numerical analysis unit, and the optimal parameter producing unit in an organic mechanism.

6. The system of claim 1, further comprising:
an error lamp controlled by a system controller to visually output an error in a process of designing and manufacturing a mold structure for high-strength steel; and
an error buzzer controlled to be operated along with the error lamp by the system controller to audibly output the error.

7. A method for designing and manufacturing a mold structure for high-strength steel, the method comprising:
step A of inputting surface topography information and physical property information about a forming material to a 3D modeling unit, by an input unit;
step B of designing a primary mold structure fitting a forming shape of the forming material by the 3D modeling unit;
step C of simulating a forming load distribution of the primary mold structure by applying stepwise forming loads to a shell of the mold structure while the forming material is formed in the primary mold structure and then detecting a wear portion in the primary mold structure, by a forming load simulation unit;
step D of analyzing a stress and degree of deformation of the wear portion based on a yield strength of an upper rib and lower rib of the mold structure and a maximum reference stress according to the forming loads;
step E of determining whether the analyzed stress and degree of deformation of the wear portion exceed a reference value;
step F of, if exceeding the reference value, deriving a correlation between parameters of length (X), width (Y), and height (Z) and a deformation rate of the wear portion, by the optimal parameter producing unit and, upon determining that it is impossible to suppress the deformation rate due to a variation in design parameter of the wear portion, providing the 3D modeling unit with a mold physical property value at which the maximum yield strength of the upper rib and lower rib is increased;
step G of designing a second mold structure to which the design parameter or physical property value varied is applied, by the 3D modeling unit;
step H of repeating steps C and D; and
step I of, if a wear portion in an Nth order mold structure resultant from performing step H falls within a preset stress and degree of deformation, providing a design parameter of the Nth order mold structure.

8. The method of claim 7, wherein the numerical analysis unit applies a different reference yield strength and a different reference maximum stress to each of the upper rib and the lower rib.
